(19) United States
(12) Patent Application Publication
(10) Pub. No.: US 2010/0077840 A1
(43) Pub. Date: Apr. 1, 2010

(54) Light induced gas sensing at room temprature

(75) Inventors: Arvind Kumar Srivastava, Des Plaines, IL (US); Vinayak P. Dravid, Glenview, IL (US)

Correspondence Address: Edward J. Timmer, Suite 205, 121 East Front Street, Traverse City, MI, 49684, US

(73) Assignee: Northwestern University

(21) Appl. No.: 12/459,193

(22) Filed: Jun. 26, 2009

Related U.S. Application Data
(60) Provisional application No. 61/133,328, filed on Jun. 27, 2008.

(51) Int. Cl. G01N 21/00; G01N 27/00; G01J 3/00

(52) U.S. Cl. 73/31.05; 356/51

(57) ABSTRACT

A light-assisted sensor and method of light-assisted sensing of gaseous species involves contacting a gaseous medium with a material selected to adsorb on its surface one or more gaseous species of interest and illuminating the surface of the material from a source to induce a change of an electrical property, such as conductivity, of the material in the presence of the one or more gaseous species. The change in the electrical property of the material is measured and can be used to identify and quantify the gaseous species of interest in the gaseous medium.

### RELATED APPLICATION

This application claims priority and benefits of provisional application Ser. No. 61/133,328 filed Jun. 27, 2008, the entire disclosure of which is incorporated herein by reference.

### CONTRACTUAL ORIGIN OF THE INVENTION

This invention was made with government support under Contract No. EEC-0118025 awarded by the National science Foundation. The government has certain rights in the invention.

### FIELD OF THE INVENTION

The present invention relates to light-assisted sensing of gaseous species including hydrogen, oxygen, and volatile organic compounds wherein sensing can be conducted at room or ambient temperature.

### BACKGROUND OF THE INVENTION

The majority of the current solid-state sensors for gas detection are made of polycrystalline metal oxides, such as tin oxide (SnO₂), zinc oxide (ZnO) etc. Their conductivity is due to non-stoichiometric composition as a result of oxygen deficiency; hence they exhibit n-type of behavior. The electrical behavior of these metal oxides with active grain boundaries is governed by the formation of double Schottky potential barriers at the interface between adjacent grains. This formation is the result of charge trapping at the interface. When the metal oxide is placed in an air ambient, oxygen molecules are adsorbed on the surface. Adsorbing oxygen takes electrons from trap states present at the adjacent grains to form O₂⁻, O⁻, O²⁻ ions [1], thus decreasing the conduction band concentration (charge carriers) near the surface and giving rise to a depletion layer. So the band bending occurs, forming a barrier at the interface. When exposed to a reducing gas, co-adsorption and mutual interaction between the reactants (reducing and surface oxygen) result in oxidation of reducing gas [2]. This oxidation phenomenon helps in removal of surface oxygen ions from the surface, resulting in decrease of barrier height, thus increasing the conductivity. At the room temperature, surface adsorbed oxygen are thermally stable, therefore high temperature (300-400° C.) is required to knock them out. High temperature of metal oxide is undesirable for two main reasons:
i. Gases susceptible to fire or explosion cannot be detected safely. One of the examples is hydrogen detection which takes only a small amount of energy (about 0.02 milli joules) to ignite it and make it burn. It also has a wide flammability range, meaning it can burn when it mixes up 4 to 74 percent of the air by volume [3].
ii. High temperature operation of metal oxide sensors has reliability issue due to the problem of sensor stability. The problem of stability is associated with the fact that oxide-based sensors consist of an incompletely sintered body in which the inter-granular contacts are not identical. The electrical response can be considered a collective phenomenon based on the existing distribution of the contact area and barrier height. In other words, a Schottky barrier gas sensor can be considered as an assembly of micro-sensors at the inter-granular contacts. At relatively high temperatures, this distribution may change with time due to the change in microstructure and/or segregation of impurities, and results in aging or long-term drift [4].

### SUMMARY OF THE INVENTION

The present invention provides a method of light-assisted sensing of one or more gaseous species, typically, gaseous molecules that can be conducted at room or ambient temperature. In an illustrative embodiment of the present invention, the method of light-assisted sensing involves contacting a gaseous medium with a material selected to adsorb on its surface one or more gaseous species of interest, illuminating the surface of the material to induce a change in an electrical property of the material, and measuring the change that is indicative of the presence of the gaseous species of interest. The method can be practiced to sense (identify) and quantify, if desired, the gaseous species of interest in the gas medium. Particular illustrative method embodiments can sense gaseous species that include, but are not limited to, volatile organic compounds such as methanol, ethanol, chloroform, acetone and/or benzene, hydrogen, or oxygen.

In other embodiments of the present invention, the sensing material can be in the form a thin polycrystalline metal oxide film or line having nano-grain size, or other forms or shapes having a polycrystalline grain microstructure, nanoparticle structure, or colloids on an electrically insulating substrate. The change in the electrical property of the sensing material is measured by electrodes.

The present invention provides a light-assisted sensor comprising a material selected to adsorb on its surface one or more gaseous species of interest and a source of illumination for illuminating the surface of the material to induce a change of an electrical property (e.g. electrical conductivity) of the material that is indicative of the presence of the one or more gaseous molecules of interest. The sensor can be used at room or ambient temperature for sensing one or gaseous species without heating during the sensing period.

The present invention is advantageous for use where there is a risk of explosion such as in hydrogen detection, where there is a desire to reduce power consumption compared to heated sensors or a desire to employ battery power, and where there is a need for a stable sensor microstructure over time which reduces or eliminates the need for periodic calibration and base line correction.

Advantages and features of the present invention will become more apparent from the following detailed description taken with the following drawings.

### BRIEF DESCRIPTION OF THE DRAWINGS

FIG. 1 is a physical model of the modulation of surface adsorbed oxygen on zinc oxide under UV illumination.

FIG. 2a is a SEM secondary image of a ZnO thin film prepared by spin coating 0.1 M zinc acetate in ethanol on SiOₓ/Si substrate followed by high temperature annealing at 700 degrees C. for 1 hour at 5 degrees C./min ramp rate in ambient air. FIG. 2b is an AFM topology image of the ZnO thin film showing porous and grainy morphology, which are desirable features for a gas sensor.

FIG. 3a is an SEM image of soft-eBL patterned miniature ZnO sensor pursuant to an embodiment of the invention. FIG. 3b is a plot showing that conductivity of ZnO increases with UV intensity due to desorption of oxygen ions with photoexcited holes which in turn gives enhance carrier density. The 365 nm wavelength LED (optical power=1200-3400 μW), FIG. 3a, was used as the UV illumination source whose intensity was varied by applying different d.c. bias across its terminals.

FIG. 4a is a Nyquist plot of ZnO thin film over a frequency range from 40 Hz to 110 MHz (amplitude 500 mV) after 15 minutes under different UV illuminations in constant oxygen background (flow rate=100 sccm). FIG. 4b is a Nyquist plot of ZnO thin film over a frequency range from 40 Hz to 110 MHz (amplitude 500 mV) after 15 minutes exposed to different oxygen concentrations under fixed UV illuminations (4V d.c. bias). FIG. 4c illustrates a proposed equivalent circuit.

FIGS. 5a and 5b show variation of grain boundary resistance (5a) and grain boundary capacitance (5b) with increasing UV intensity in constant oxygen background (100 sccm). FIGS. 5c and 5d show variation of grain boundary resistance (5c) and grain boundary capacitance (5d) with increasing oxygen concentration in fixed UV intensity (4.0V d.c.).

FIG. 6a is an activation energy plot of ZnO thin film illuminated with different UV intensities in constant oxygen background (100 sccm). FIG. 6b is an activation energy plot of ZnO thin film illuminated with different oxygen concentrations and fixed UV intensity (4.0V d.c.). FIG. 6c is a plot of change in barrier height calculated from FIG. 6a. FIG. 6d is a plot of change in barrier height calculated from FIG. 6b.

FIG. 7a shows a typical response of ZnO chemoresistor to methanol under UV illumination. FIG. 7b shows PCA scores and loading plots showing cluster of the test VOC's in 2D (two dimensional) space and how good is the contribution of the selected UV intensities in spatial distribution of the clusters. Reference numbers 1, 2, 3 (e.g. a1, a2, a3, . . . ) indicate concentration of the test VOC's as 10, 20, and 30 sccm, respectively.

FIGS. 8a and 8b illustrate identification of VOC's using artificial neural networks. FIGS. 8c and 8d illustrate quantification of VOC's using artificial neural networks.

FIGS. 9a, 9b, and 9c show room temperature sensitivity (S) of ZnO polycrystalline nanolines (100 nm and 400 nm wide) to hydrogen as compared to sensitivity S of ZnO thin film and a commercially available Figaro hydrogen sensor (model TGS821) under UV illumination.

FIG. 10 is a schematic view of the experimental set-up.

FIG. 11 shows a scheme for identification and quantification of VOC's using sensor arrays and principal component analysis (PCA) and artificial neural networks (ANN's).

FIG. 12 is a flow chart of a top-level description of back-propagation neural network.

FIG. 13 is schematic of learning procedure in ANN.

FIG. 14 is a schematic of testing system.

### DETAILED DESCRIPTION OF THE INVENTION

The present invention involves a method of light-induced sensing of one or more gaseous species in a gaseous medium at room or ambient temperature using a sensing material selected to adsorb on its surface one or more gas species of interest and illuminating the material surface, such as with ultraviolet (UV) light, during contact of the gaseous medium and the material during a sensing period to induce a change of an electrical property (e.g. electrical conductivity) of the material that is indicative of the presence of a gaseous species of interest. For purposes of illustration and not limitation, room or ambient temperature sensing can comprise a range of temperatures encountered in particular testing environments and facilities, typically less than 35 degrees C. such as from 7 to 32 degrees C. and more typically from 20 to 30 degrees C. The invention is practiced with UV light that has an energy selected to be equal to or greater than the band gap of the sensing material (semiconducting metal oxide). For purposes of further illustration and not limitation, UV light typically can be used having a wavelength of 400 nm or less (3.1 eV or higher energy) such as, for example, 400 nm (3.1 eV energy) to 200 nm (6.2 eV energy), although the invention is not limited in this regard.

The gaseous medium can include, but is not limited to, ambient or atmospheric air that may have one or more gaseous species or molecules of interest therein, an artificial atmosphere such as a heat treatment atmosphere, synthetic gases and gaseous mixture. Gaseous species (molecules) which can be sensed at room or ambient temperature include, but are not limited to, volatile organic compounds (VOC's) such as methanol, ethanol, chloroform, acetone and/or benzene, or other gas molecules such as hydrogen, oxygen, carbon monoxide, nitrogen dioxide, and sulfur dioxide. In the Examples herebelow, ultraviolet (UV) light is employed for illumination of the material surface during the sensing period and the recovery period of the sensor, but practice of the invention is not limited thereto in that other light may be used to practice the invention including, but not limited to, visible light illumination (e.g. wavelength above 400 nm to 700 nm) during the sensing period (exposure to gas) followed by moderate sensor heating (e.g. to 70-80 degrees C.) during a sensor recovery period carried out to return the sensor to its original state. Moderate heating of the sensor can be provided by a heating layer provided on or in the substrate adjacent or underneath the sensing material and separated therefrom by silicon oxide insulating layer, or by other suitable heating means, and energized to generate suitable heating of the sensing material.

In one embodiment of the invention, the UV light can be maintained constant in intensity and energy for the sensing period (gas exposure period) and for a recovery period of the sensor following the sensing period. In another embodiment of the invention, multiple sensors each can be illuminated with different UV light intensities to test for and detect different multiple gases in a test gas mixture as well as individually. For example, using an array of multiple sensors of the invention, each of the sensors can be illuminated with a different UV intensity and/or energy such that sensors will respond differently to one type of gas whereas for a different type of gas they will have different unique response, and for a third type of gas they will have completely different response and so on. Using suitable data analysis and pattern recognition techniques, multiple gases of interest can be detected individually as well as in a gas mixture. In still another embodiment of the invention, a single sensor of the invention can be illuminated with periodically changing UV intensity and/or energy to detect multiple gases of interest individually as well as in a gas mixture. For example, a single sensor can be illuminated with UV light whose intensity and/or energy is varying in periodic fashion (e.g. sinusoidal fashion, saw tooth fashion, triangular fashion, or in square wave fashion). For such sensor when kept in constant air background, the sensor response will follow the way UV light is modulated. For example, if the sensor is illuminated with sinusoidally changing UV light, the measured sensor response (resistance or conductivity) will be sinusoidal. When the sensor is exposed to a test gaseous medium, its output waveform will be distorted. For each test gas, output response will be distorted differently. Such a distorted waveform provides useful information about the test gas under investigation. Using suitable signal processing techniques, such as Fast Fourier Transform or Discrete Wavelet Transform, multiple gases of interest can be detected in a gas mixture as well as individually.

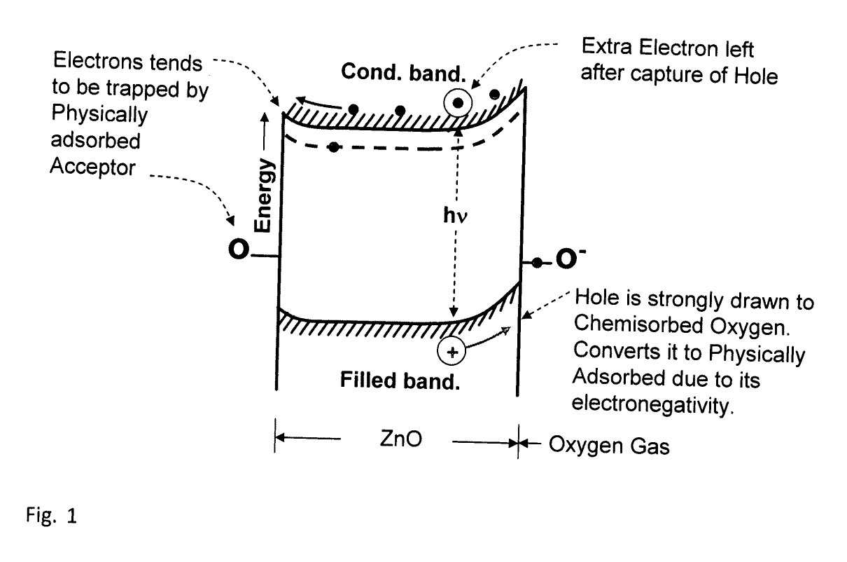

Materials that can be employed in practice of the invention typically comprise a polycrystalline metal oxide n-type semiconductor material having a wide band gap (e.g. 3.6 eV) and are selected to absorb one or more species of interest on its surface in ambient air or other atmosphere. For n-type metal oxide semiconductors that are wide band gap materials, when illuminated with light with energy higher than the band gap, holes which are produced by the light adsorption near the surface migrate to the surface along the potential slope created by the band bending due chemisorbed surface oxygen which acts as an acceptor type impurity. The hole, if sufficiently close to these impurity levels, is attracted to the charged oxygen molecules on the surface. The oxygen loses its charge and therefore becomes physically adsorbed and loosely bound, FIG. 1, and hence are readily available to react with the target gas. This can be monitored as a change in conductivity/work function of the metal oxide.

The n-type materials exhibit two parameters: size of grains and dimension of patterned oxides that are important. That is, as the size of the grains decreases, sensor sensitivity increases. As the Debye screening length (λ_{D}) approaches half of the grain diameter (D), bulk effect contribution to overall sensor resistance gradually diminishes and surface effect dominates. Under this condition, even a small change in surface charge density due to gas adsorption will make a large change in overall sensor resistance. However, the sensitivity of such polycrystalline metal oxides in 2D (two dimensional) form (thin film) is often limited by poor signal to noise ratio due to their high operating temperature. This makes low concentration detection difficult. This can be improved by reducing the dimensions of patterned oxides and by illuminating the sensor surface with UV or other illumination pursuant to the invention.

For purposes of illustration and not limitation, zinc oxide material is described in the Examples below and adsorbs VOC's and hydrogen on its surface to permit detection of these gaseous molecules in a gaseous medium. Other n-type metal oxide materials which can be used include, but are not limited to, SnO₂, In₂O₃, WO₃, Ga₂O₃ and TiO₂ material for detection of CO, CO₂, O₂, O₃, NO, NO₂, H₂S and complex VOCs.

Metal oxide p-type semiconductor materials also can be used in practice of the invention where upon exposure to oxygen, conductivity of the p-type metal oxide materials will increase due to addition of extra holes, while conductivity of n-type metal oxide materials will decrease. P-type metal oxides that can be used include, but are not limited to, Cr₂O₃, Cr₂₋ₓTi_{y}O_{3+z}, NiO and CoO.

To enhance the selectivity of these metal oxides for the target gaseous molecule, catalytic metal additives like Pd, Pt, Au, Ni, Cu, Cd, Co, Ti, Al, Ru and V can be added into the n-type or p-type base metal oxide. The metal oxide materials typically are in the form of a polycrystalline 2D thin film or layer, or one or more spaced apart 1D lines on an electrically insulating substrate wherein the thin film/layer or line has a nano-grain size less than about 100 nm with a thin film/layer thickness of less than about 100 nm and line width less than about 100 nm, although any other shape or form of the material can be used in practice of the invention.

Typically, the sensor response (whether it is n-type sensor or p-type sensor) is measured with respect to base line in air background. Since the response of an n-type sensor is opposite to that of a p-type sensor, both an n-type sensor and p-type sensor can be concurrently exposed to a test gas medium to detect the gas(es) of interest even more sensitively by taking the sum of the responses of both the n-type sensor and the p-type sensor.

The EXAMPLES herebelow illustrate photo-illumination modulation of the surface adsorbed oxygen of a nano-grain size polycrystalline zinc oxide thin film (less than 100 nm thick) and exposed to varying concentrations of oxygen under different UV illuminations. Impedance Spectroscopy (IS) was used as a tool to study the effect of UV light on surface adsorbed oxygen. Through the non-linear curve fitting (NLLSFIT) of impedance plots, grain boundary resistance was found to be main contributing factor in controlling ZnO conductivity change, which is basically governed by the change in surface oxygen concentration. Activation Energy (AE) plots and Surface Potential Measurement (SPM) of the ZnO thin film with and/without gas and/or UV exposure also support modulation of surface oxygen with UV light which can be used as a basis for room temperature detection. Based on these findings, other Examples herebelow demonstrate the detection of test chemicals with ZnO illuminated with different UV intensities. Response patterns thus generated were analyzed by Principal Component Analysis (PCA) and then processed with Artificial Neural Network (ANN) pattern classifier for identification and quantification.

### EXAMPLES

### VOC Detection

### Experimental

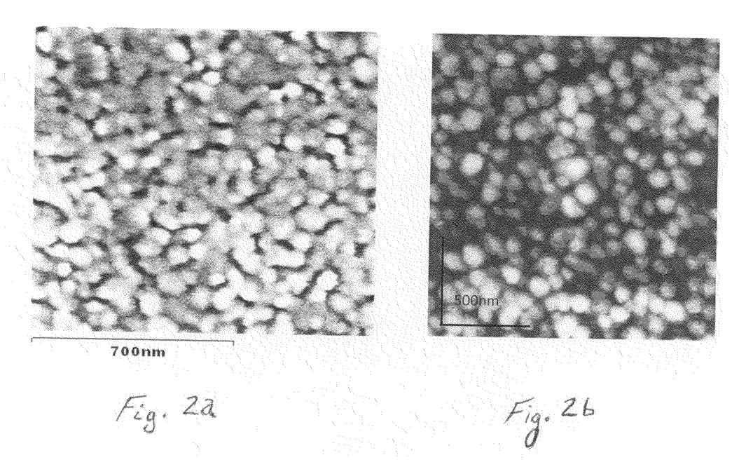

To demonstrate the effect of UV radiation on the modulation of surface oxygen, an experiment was performed with a thin film of zinc oxide prepared by sol-gel method. Zinc oxide sol was prepared by stirring a 0.1 M solution of zinc acetate dehydrate (Zn(CH₃COO)₂.2H₂O 99.999%, Sigma-Aldrich) in ethanol with subsequent drop by drop addition of diethanolamine (DEA: HN(CH₂CH₂OH)₂ 99%, Sigma-Aldrich) as sol stabilizer at 60° C. for 2 hours until a clear transparent and homogeneous solution was obtained [6]. The solution of was spun at 3000 rpm for 45 seconds onto SiOₓ/Si substrate (n-type <100> silicon with 140° A thermally grown oxide) followed by high temperature annealing at 700° C. for one hour in air ambient for crystallization. Scanning Electron Microscope (FEI Quanta 600 FEG ESEM) and Atomic Force Microscope (Digital Instruments Nanoscope MultiMode III AFM) images of the sintered zinc oxide film showed grainy and porous structure with average grain size of ≈80 nm and thickness <100 nm, FIGS. 2a and 2b). Energy Dispersive Spectroscopy (EDS) patterns taken from the ZnO film discloses that these nanosized grains (less than 100 nm) are composed chemically of zinc and oxygen whereas polycrystallinity nature of these grains was determined by X-Ray Diffraction (XRD: ATX-G, Rigaku, Japan).

Fabricated ZnO thin film was characterized in different oxygen backgrounds under varying UV intensities with no heating of the thin film. Two sets of experiments were carried out: (a) ZnO illuminated with different UV intensities in constant oxygen ambient, and (b) exposed to different oxygen concentrations under fixed UV illumination. UV LED (Model: NSHU550B, λ=365 nm and optical power=1200-3400 μW, Mfr.: Nichia Corp.) was used as UV source, whose intensity was varied by applying 3.2V to 4V d.c. bias across its terminals in the interval of 0.2V. Testing was carried out in a test chamber fitted with MKS647C Mass Flow Controller/MFC1479 Flow Meters for regulated flow of oxygen from 100 sccm to 5 slm.

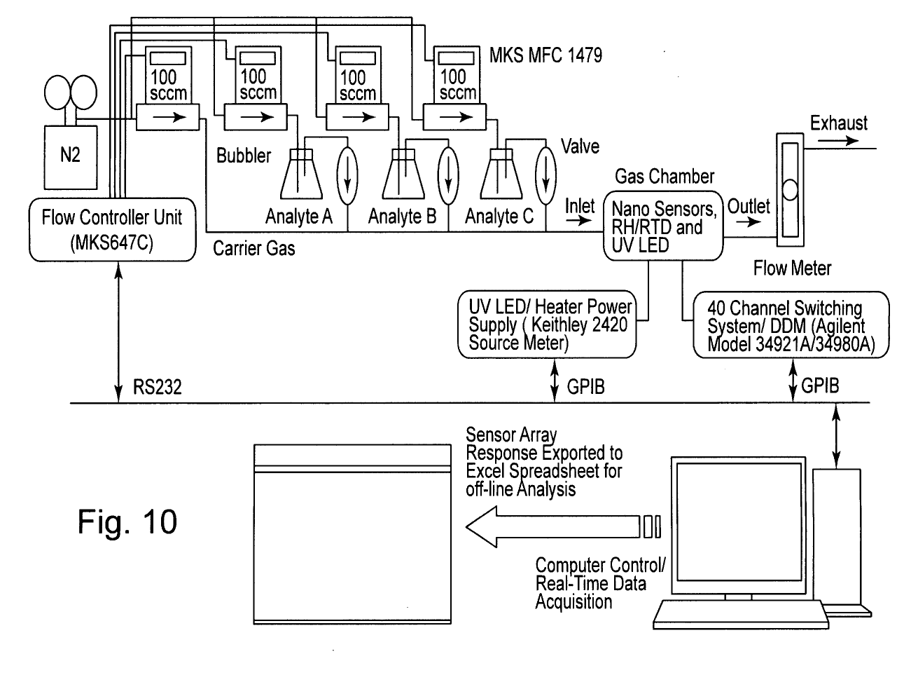

Referring to FIG. 10, the experimental set-up used for the characterization of nano-sensors is shown. It consists of a gas chamber, a gas delivery system based on Multichannel Flow and Pressure Controller Unit (MKS647C) and a set of Flow Meters (MFC 1479) for gas mixing and flow rate regulation, power supply (Keithley Model 2420 Source Meter) for sensor excitations, High Density Switching and Measurement System (40 channel multiplexer (Agilent Model 34921 A)/multifunction switching system (Agilent Model 34980A) with built-in high precision digital multimeter) for simultaneous measurement of sensor resistance, and a personal computer that communicates over GPIB and RS232 interface. Entire process right from sensor diagnostics, sensor excitation (static/dynamic heat/light induced sensing), flow-rate control, purge and exposure sequence and measurement of sensor response can be initiated, controlled and terminated by the “NanoNose™” software developed in LabVIEW™. Data from the sensor array are recorded in real-time at the rate of 10 samples/sec and stored in a spreadsheet for further offline analysis. Gas chamber is installed with humidity and temperature sensors (Honeywell Model HIH-3602-L IC) for monitor fluctuation in humidity and ambient temperature. Humidity and temperature data can be used for compensating effect of humidity and temperature fluctuations on sensor response. Appendix I provides further details of experimental hardware.

Two types of electrical characterizations were done. To see the individual contributions of grain boundary resistance and bulk resistance impedance spectroscopy (IS) measurements were done using precision impedance analyzer (HP4294A) in the frequency range from 40 Hz to 110 MHz. Schottky barrier height across the adjacent grains was estimated by means of activation energy plots in the temperature range from 300K and 415K. All these measurements were done after the sample had reached steady state in about 15 minutes of gas and/or UV exposure.

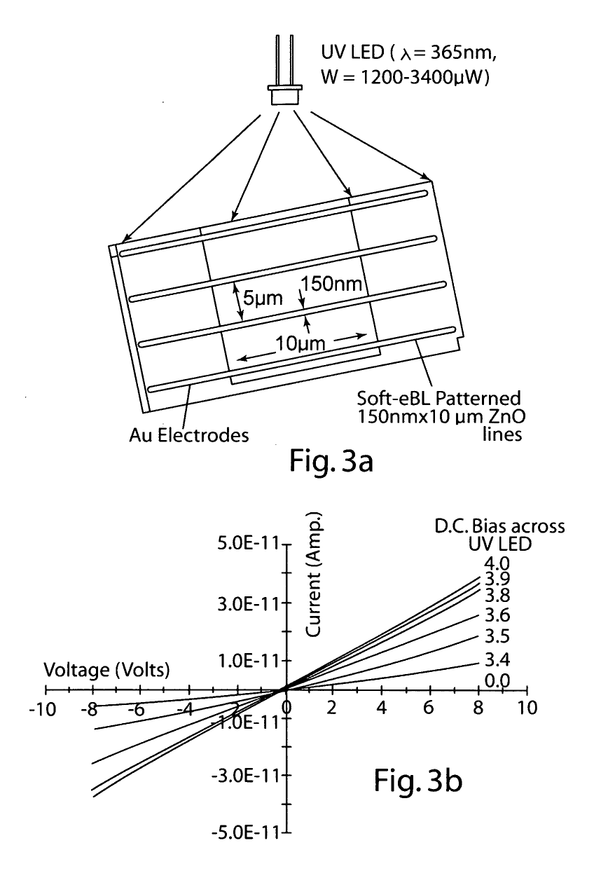

For the actual gas sensing experiments, miniature sensor was fabricated using the technique called, soft-eBL (electron beam lithography) that synergistically combines advantages of electron beam lithography and solution chemistry that has the capability of site-specific patterning of ceramic oxides and conducting polymers on a variety of conducting and non-conducting substrates (e.g. ZnO on Saphire, ZnO on SiOₓ, SnO₂ on SiOₓ, ferromagnetic magnetic CoFe₂O₄ (CFO) on SrTiO₃/MgO/SiOₓ, ferroelectric BaTiO₃ on SrRuO₃/SrTiO₃/SiOₓ, ferroelectric Pb(Zr,Ti)O₃ (PZT) on Pt/SrTiO₃, multiferroic BiFeO₃ on SrTiO₃/Pt/SiOₓ, polymeric materials like polypyrrole and polyaniline on SiOₓ including hybrid nanostructures consisting of ferroelectric Pb(Zr,Ti)O₃ (PZT) shell with magnetic CoFe₂O₄ (CFO) core) with high spatial resolution (less than 50 nm) and precise registry. Depending-upon the substrate, both the single crystal and polycrystal nano-structures can be fabricated. FIG. 3a is an SEM image of miniature ZnO sensor which is made by soft-eBL technique [7]. To fabricate the ZnO sensor a pair 10 micron apart gold (Au) electrodes are first patterned using photolithography on a SiOₓ/Si substrate. The electrodes allow conductivity or resistance changes of the ZnO material to be measured. Next step is patterning of ZnO lines across the gold electrodes following procedure as described below.

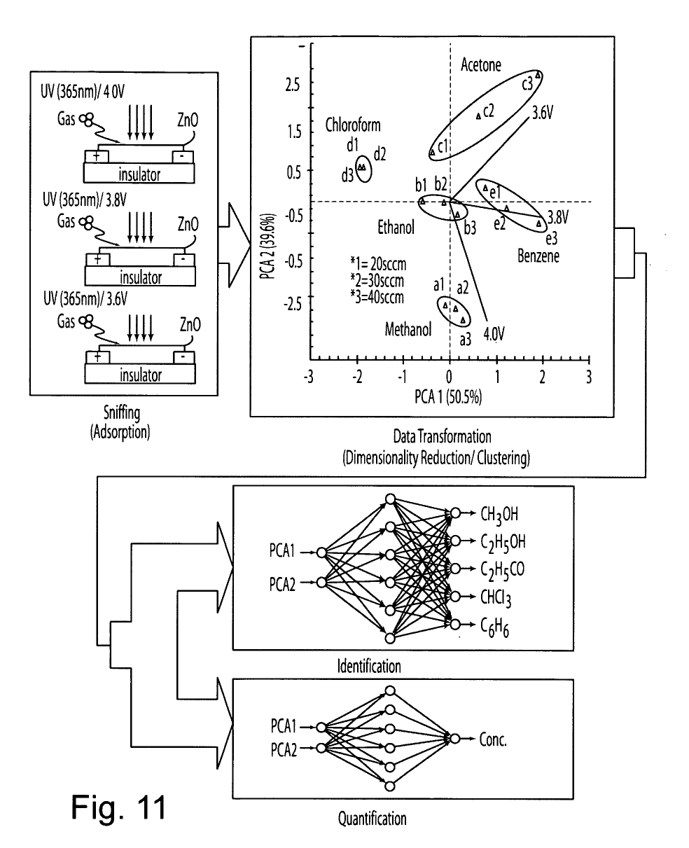

The first step is to sequentially spin-coat the substrate with a bilayer structure of electron beam (e-beam) resists having high sensitivity MMA-MAA copolymer (MMA(8.5) MAA EL6) at the bottom and a low sensitivity PMMA (950PMMA A3, from MicroChem) resist on top. The higher sensitivity of the copolymer compared to PMMA affords excellent liftoff. Each layer is spin-coated at 3000 rpm for 45 seconds to give a nominal thickness of about 150 nm. E-beam resist coated substrate was patterned with multiple lines (200 nm wide and 20 micron long) at an interval of 5 microns across the gold electrodes using the Quanta 600F (FEI Co.) electron-beam lithography machine operated at 30 kV with line doses between 0.8 and 1.2 nC/cm. The same machine is used for subsequent imaging of the patterns. The patterned substrate was then treated with oxygen plasma for 20 s (75 W, 50 sccm flow rate, 75 mTorr operating pressure). The purpose of plasma treatment is not only to remove any undeveloped resist in the patterned areas but also to increase the hydrophilicity of PMMA surface. This is necessary to improve the wettability and effective filling of the patterned areas by solution. The plasma-treated patterned substrate was used immediately for spin-coating with ZnO sol precursor. ZnO sol was spun between 3000 and 6000 rpm for 45 seconds and was heated immediately on a hot plate for 5 min at 150° C. The substrates was soaked subsequently in acetone to dissolve resists, lift-off material outside the patterned areas, and generate solid amorphous ZnO structure with controlled dimensions. Patterned ZnO being amorphous in morphology, the sample was annealed at 900° C. for 5 min in air through upquenching (samples were introduced into a furnace set at the annealing temperature). Final structure when images under scanning electron microscope was found to be shrunk by about 30% in width (i.e. about 150 nm from the original patterned width), whereas the line height decreased by about 50%. This corresponds to roughly 65% volume shrinkage. While such a large volume shrinkages are not uncommon for structures fabricated using solution precursors, it is remarkable that these structures accommodate such large volume changes, and yet still retain continuity between neighboring grains of up to several micrometers along each line. Grain size of the patterned ZnO lines was measured to be 80 nm. This suggests that with this approach, it is possible to realize even much smaller grains which are desirable for designing high sensitivity gas sensors. FIG. 11 shows a sectional view of a sensor on the upper, left-hand side of the figure having a ZnO sensing material and first and second gold (Au) electrodes indicated by + and − designations that allow conductivity or resistance changes of the ZnO material to be measured.

FIG. 3b is a IV plot of the fabricated sensor at different UV intensities plot showing that conductivity of ZnO increases with UV intensity due to desorption of oxygen ions with photoexcited holes which in turn gives enhance carrier density. The 365 nm wavelength LED (optical power=1200-3400 μW, FIG. 3a, was used as the UV illumination source whose intensity was varied by applying different d.c. bias across its terminals. In particular, FIG. 3b shows ohmic behavior with full UV functionality and ready to use for sensing applications. Five different laboratory chemicals; namely, methanol (CH₃OH), ethanol (C₂H₅OH), chloroform (CHCl₃), acetone (C₂H₅CO), and benzene (C₆H₆) were chosen as volatile organic compounds (VOC's) for gas sensing experiments. Sensor was exposed to different concentrations of the test VOC's under different UV intensities equivalent to 3.6, 3.8, and 4.0 C d.c. bias across the UV LED. Saturated vapors of the test VOC's were generated by bubbling 20, 30, and 40 sccm of pure medical grade air in the test liquids maintained at 23 degree C. Total flow rate of the test gas was maintained at 100 sccm air as carrier gas. Prior to each gas exposure, sensor was energized under UV illumination in 10 sccm air ambient over an extended period of time (about 30 minutes) to establish a base line. Each of the gas exposure sequences consisted of 5 minutes of purge and 5 minutes of exposure cycle. The sensor was exposed during the purge phase to 10 sccm of air for recovery. Response of the sensor to test gases was captured by applying 5V of fixed d.c. stress across the sensor terminals (gold pads) using a Keithley 4200 Semiconductor Characterization System. All measurements were made at room temperature (23 degrees C.)

### Results and Discussion

### 1. Impedance Spectroscopic Analysis

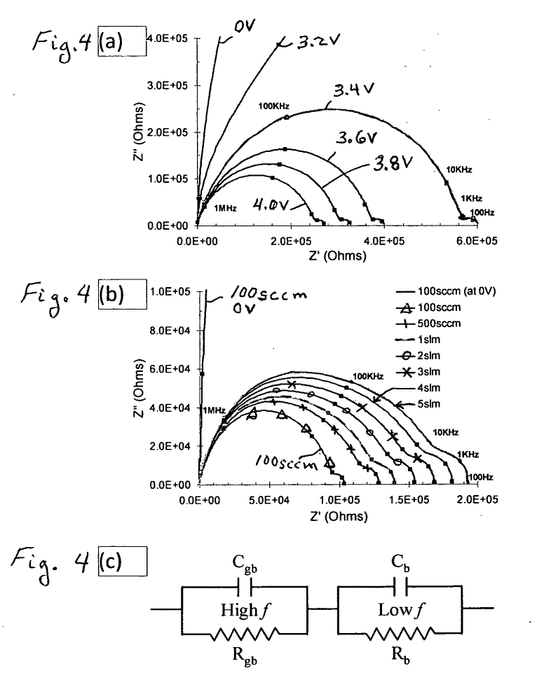

Impedance spectroscopy (IS) study over a frequency range from 40 Hz to 110 MHz was performed by exposing the ZnO thin film in different oxygen background under varying UV intensities. Two different sets of experiments or tests were done:
(a) ZnO illuminated with different UV intensities in 10 sccm constant flow of oxygen, FIG. 4a.
(b) ZnO exposed to different oxygen concentrations under fixed UV intensity equivalent to 4V d.c. bias, FIG. 4b.

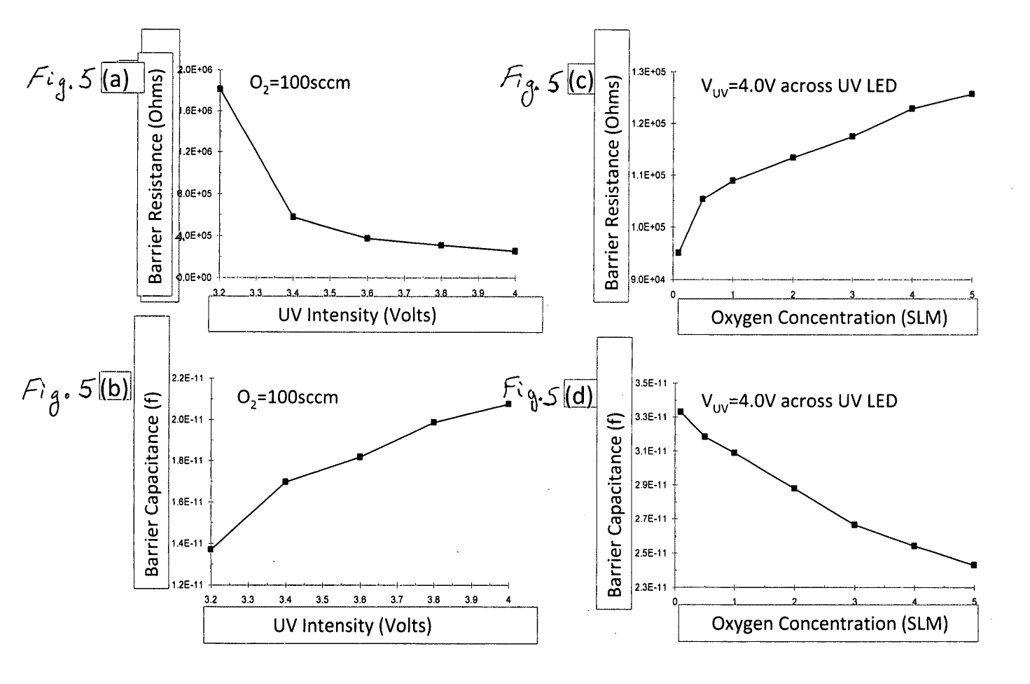

In both of these experiments, cole-cole plots show two semicircles. These plots reveal that there are possibly two RC networks connected in series as shown in FIG. 4c, to which the ZnO thin film response can be modeled. These RC networks correspond to bulk and grain boundary properties of the thin film [9]. At lower frequencies, the effect of the bulk resistance is observable due to the ion migration, while at higher frequencies Schottky barrier effect due to grain boundaries resistance is dominant. Nonlinear least square fit (NLLSFIT) of the impedance spectra show that increasing the UV intensity in constant oxygen ambient results in a decrease in the grain boundary resistance (R_{gb}) and increase in its capacitance (C_{gb}), see FIGS. 5a, and 5b, whereas increasing the oxygen concentration keeping the UV intensity constant results in reversed change of grain boundary resistance (R_{gb}) and its capacitance (C_{gb}), see FIGS. 5c and 5d.

Change in R_{bg} and C_{bg} with oxygen and/or UV can be explained as follows, although applicants do not intend or wish to be bound by any theory:

when a pristine zinc oxide is brought in contact with air, oxygen is adsorbed on the oxide surface as a negatively charged ion by capturing fee electrons of the n-type oxide semiconductor, as described by equation (1) [10]:

O₂(g)+e⁻→O₂⁻(ad) (1)

thereby creating a depletion layer with low conductivity near the surface. In polycrystalline materials, this change in conductivity is basically dominated by the intergranular contacts where the depletion layer width is twice. When the light with energy equal to or higher than the band gap of the semiconductor (λ≦375 nm equivalent to 3.3 eV, band gap of ZnO) is illuminated, holes are attracted to the negatively charged chemisorbed oxygen on the surface. The oxygen loses its charge and therefore becomes loosely bound as illustrated below:

hv→h⁺+e⁻ (2)

h⁺+O₂⁻(ad)→O₂(g) (3)

Electrons produced at the same time by light destructs the depletion layer, increasing conductivity.

Decrease (increase) in grain boundary resistance (capacitance) with UV intensity as depicted in FIGS. 5a and 5b is due to photodesorption of surface adsorbed oxygen according to Equation (3). When the oxygen concentration is increased in a fixed UV background, two competing phenomena occur. While the UV light removes the surface oxygen, at the same time additional oxygen are continued to be adsorbed and if the oxygen concentration continues to increase, rate of adsorption ultimately supersedes the rate of desorption resulting thereby in grain boundary resistance (capacitance) to increase (decrease) by capturing more and more free electrons from the zinc oxide, FIGS. 5c and 5d.

### 2. Activation Energy Measurement

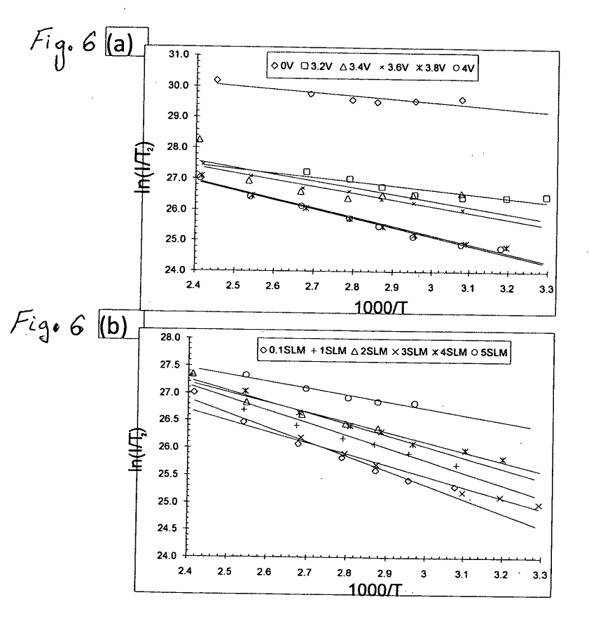

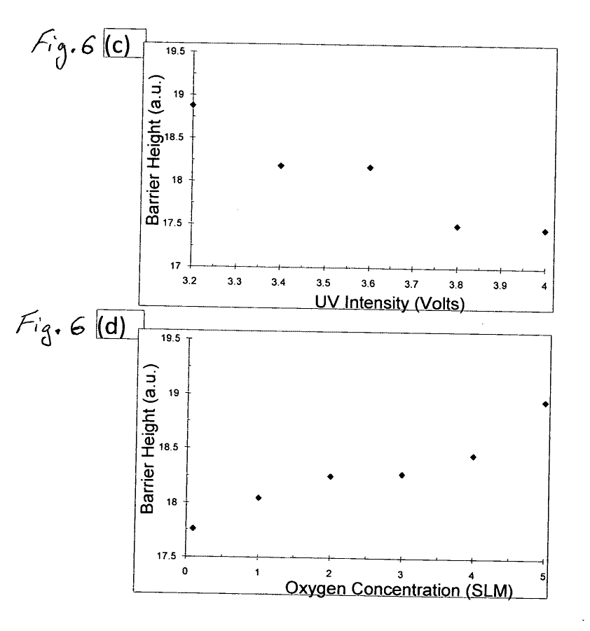

Referring to FIGS. 6a and 6b, these figures show ln I/T² plots for ZnO illuminated with different UV intensities in constant oxygen background and ZnO exposed to different oxygen concentrations under fixed UV illumination, respectively. Variation in barrier heights for each of these two tests as extracted from FIGS. 6a and 6b is plotted in FIGS. 6c and 6d. It is found that as the intensity is increased, barrier height decreases due to photodesorption of surface oxygen trapped at the interface of grains. Whereas increasing the oxygen concentration results in increase in barrier height due to adsorption of additional oxygen at the interface causing depletion layer to widen by trapping the charge carriers near the surface. Change in ZnO conductivity due to oxygen/UV adsorption is in agreement with IS results. [Note that change in barrier height for each tests (a) and (b) as discussed above is calculated from the ln I/T² versus 1/T plot of the Schottky equation as given below [14]:

$$ln ( \frac{I}{{T}^{2}} ) = ln ( A ) - \frac{q ( {Φ}_{B} - V )}{kT} \qquad ( 4 )$$

where Φ_{B} is the barrier height, V is the applied voltage, I is current, T is temperature and A is Richardson constant. For a given forward voltage, slope of ln I/T² versus 1/T plot yields barrier height.]

Impedance spectroscopy analysis and activation energy measurement results suggest that due to the modulation of surface oxygen concentration of ZnO under UV illumination and hence corresponding change in its resistivity, illuminated ZnO material can be used as an excellent oxygen sensor as well in another embodiment of the invention.

### 3. Detection of Volatile Organic

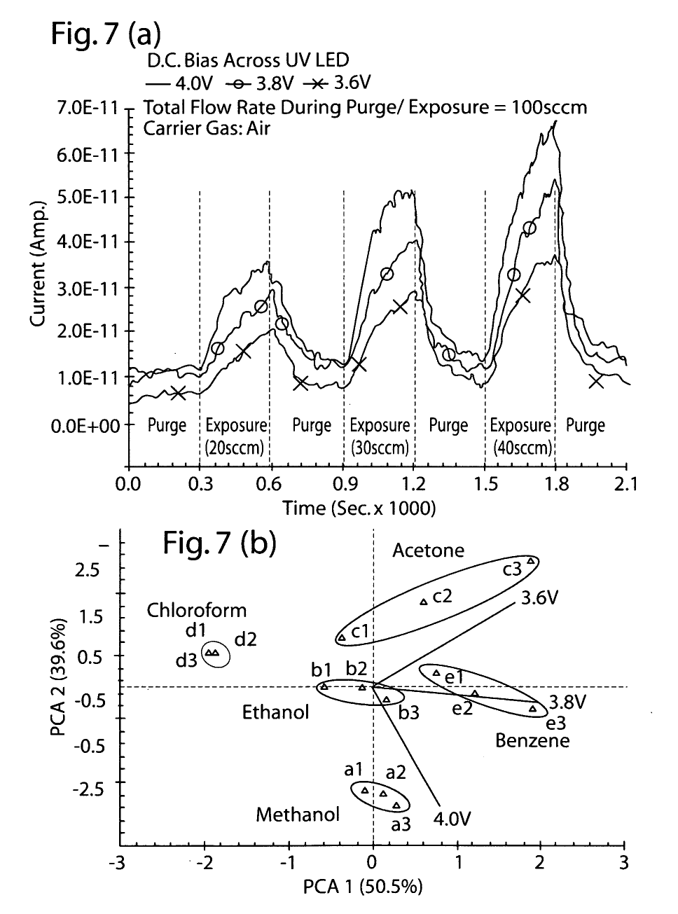

For detection of VOC's, a systematic experiment was performed by the exposing miniature sensor, FIG. 3a, to 20, 30, and 40 sccm of methanol, ethanol, chloroform, acetone, and benzene diluted respectively with 80, 70, and 60 sccm of air under varying UV intensities (3.6, 3.8, and 4.0V d.c. bias across the UV LED source) as described above. Typical response of the ZnO sensor to one of the test gases methanol under different UV intensities is shown in FIG. 7a. Unlike conventional high temperature gas sensing which involves chemisorbed oxygen in chemical detection, mechanism of light-assisted gas sensing pursuant to the invention is controlled by physisorption where holes generated due to UV illumination are captured by the negatively charged chemisorbed surface oxygen. Under the influence of high electric field, the neutral surface oxygen thus created are polarized and become loosely bound or physically adsorbed on the surface of the zinc oxide, although applicants do not intend or wish to be bound by any theory in this regard. Oxygen may be physically adsorbed due to its strong electronegativity which has a tendency to attract surface electrons. Photoelectrons produced at the same time destruct the depletion layer by neutralizing positively charged interstitial zinc ions on the surface. This increases the conductivity by several order of magnitude depending upon the UV intensity as can be seen in FIG. 7a. Physically adsorbed oxygen on the surface of zinc oxide soon achieves equilibrium with the surrounding atmosphere. When it comes into contact with reducing gas, this equilibria is disturbed by forming oxygen complex with the target gas or its photodissociated constituents [17], which can be monitored as a change in surface conductivity/work function. In addition, when ZnO is illuminated with UV light, a large number of additional photo-induced oxygen ions (These oxygen ions are produced by combining atmospheric oxygen with the photo-electrons. These oxygen ions are not chemisorbed ions. They are in metal-stable state and disappear as the UV light is turned off.) that are produced participate in the reaction with the test gas. The response of ZnO to methanol as shown in FIG. 7a, being highly reproducible, suggests it is a cumulative effect of both physisorbed oxygen ions and photo-induced oxygen ions that result in the observed change in ZnO conductivity, although again applicants do not intend or wish to be bound by any theory in this regard. When UV light is turned off, response of the sensor to test VOC gas was hardly detectable or was not seen at all.

Like high temperature response of metal oxides, light induced response of ZnO to the test VOC's when plotted together show partially overlapping sensitivity. ZnO illuminated with different UV intensity show different degree of sensitivity for a given gas, whereas different responses are obtained for different VOCs at a fixed UV intensity. Principal component analysis (PCA) [8], FIG. 7b, of the data sets thus generated from the ZnO response to the test VOCs at different UV excitations show well separated clusters with an ordered spatial distribution along the direction of increasing concentrations in 2D feature space of first two principal components (PC) having cumulative variance of 90.1% (score plot). Relative contribution of different UV intensities to spatial distribution of VOCs clusters, as depicted in PCA loading plot, suggest that the selected UV intensities are good choice for detection purpose. Data sets used in PCA plots are sensor sensitivity after 5 minutes of gas exposure. Sensitivity of the sensor was calculated with respect to the base line resistance (in first 300 second during purge phase) for each of the UV intensities used.

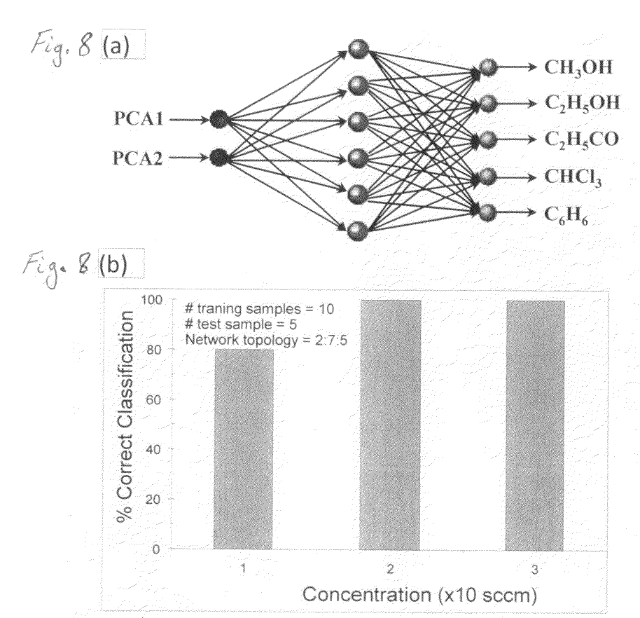

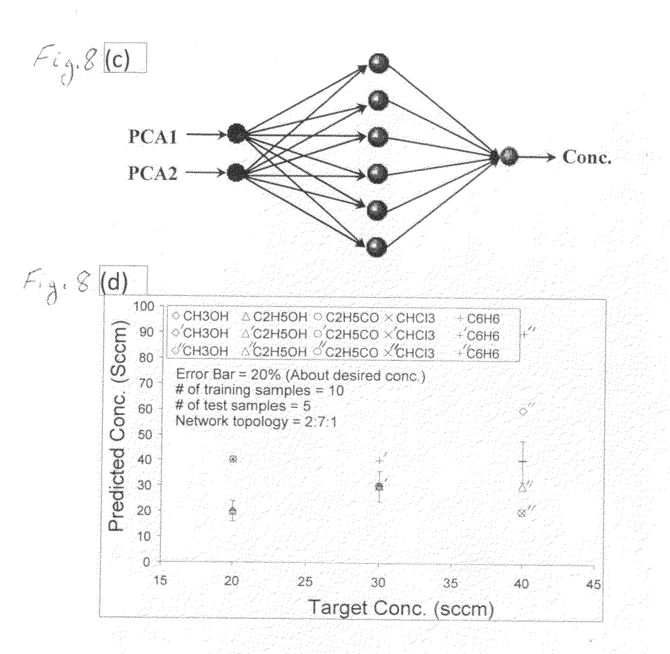

In order for the automated detection of VOC's, three-layered feed forward neural network (NN) with sigmoidal activation function was trained using backpropagation learning algorithm [19] over the date sets consisted of the normalized PC1 and PC2 (obtained from PCA plot of FIG. 8 and normalized between 0 and 1). Two types of neural networks were constructed-one for identification, FIG. 8a, and one for quantification, FIG. 8c. Input layer consists of two nodes corresponding to PC1 and PC2, whereas output layer contains nodes equal to the number of vapors requiring discrimination (for quantification purpose, output layer consists of only one node to predict concentration of the test vapor). Number of nodes in the input layer was chosen by trials after repeated restarts and different weight initialization. 67% of the total data set was used for training the neural network and the remaining 33% data, which were never ever shown to the network, were used for testing. Details of neural network design and training procedure can be found in Appendix II and reference [8] and [20], which are incorporated herein by reference. Results of VOC identification and quantification are presented respectively in FIG. 8b and FIG. 8d. Neural network processing of ZnO response to test VOC's under UV illumination results in approaching 100% classification accuracy whereas quantified samples, except those at higher concentrations and a few at lower concentrations (e.g. 20 sccm of C₂H₅CO, CHCl₃, C₆H₆ and 30 sccm of C₆H₆), fall within 20% of error. Using the above-described subsequent data processing employing statistical and artificial neural network approach (ANN), applicants successfully identified the test VOC's but also most of them, particularly at low and intermediated concentration range, were quantified.

As is apparent from the Examples, the modulation of surface adsorbed oxygen by UV illumination and resulting changes in conductivity, as evidenced by the impedance spectroscopy measurement, was successful as a method of achieving room temperature sensitivity to VOC's. The resulting change of conductivity is dominated by the intergranular contacts in polycrystalline zinc oxide in the Examples. The amount by which zinc oxide conductivity changes is typical for each gas and UV intensity, which if considered collectively constitutes an unique pattern as a signature of chemical information. Using the above-described subsequent data processing employing statistical and artificial neural network approach (ANN), applicants successfully identified the test VOC's but also most of them, particularly at low and intermediated concentration range, were quantified.

Drift in baseline resistance due to continuous loss of interstitial oxygen ions under UV exposure over an extended period of time. Oxygen vacancies thus created can be filled only at elevated temperature (about 300° C.) to bring the baseline resistance back to original value. Pulse UV illumination is an option envisioned by the invention that can be used to alleviate this issue. Unlike continuous UV exposure, response of sensor to pulse UV light might provide plethora of useful information about gas-solid interaction and hence can be used to detect suspect chemical even with greater confidence.

### 4. Detection of Hydrogen

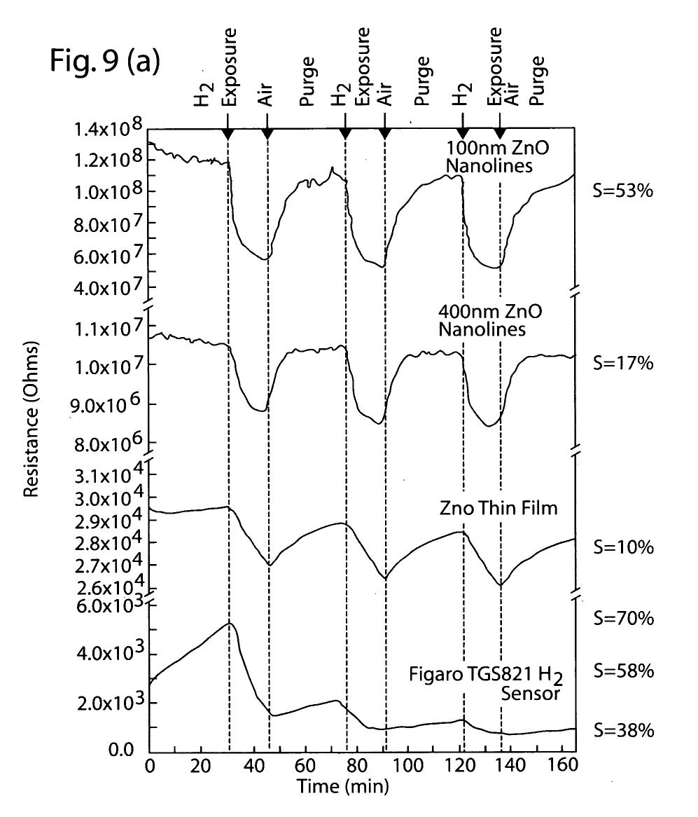

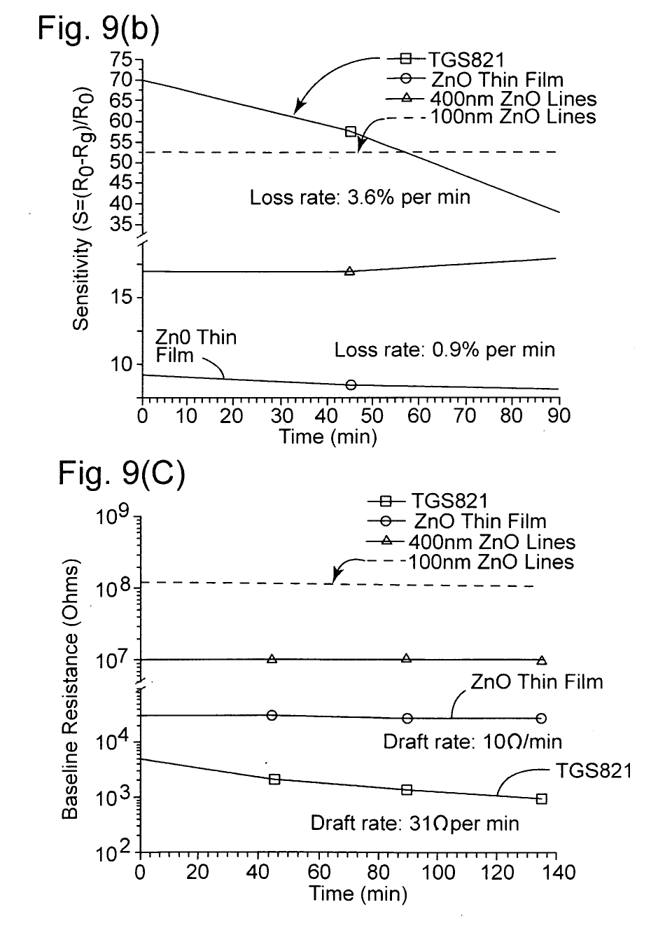

Similar to the approach described in previous section for VOC detection, one dimensional (100 nm and 400 nm line width) and two dimensional (thin film) polycrystalline ZnO sensors were fabricated across pre-fabricated gold electrodes and were tested for their sensitivity to hydrogen gas detection. Room temperature sensitivity is achieved by illuminating the patterned metal oxides with 365 nm wavelength UV light. FIG. 9a shows comparative response of ZnO lines, ZnO thin film and Figaro hydrogen sensor (model TGS821) to repeated exposure of hydrogen gas at room temperature. The sensors were exposed to 2.5% of hydrogen in air at a total flow rate of 200 sccm. As compared to ZnO thin film sensor commercially available TGS responds poorly to the hydrogen gas. With the periodic exposure to hydrogen gas there is not only drop in sensitivity (S) from 70% to 38% but also TGS sensor suffers from the base line drift due to incomplete desorption of adsorbed hydrogen. Whereas in ZnO thin film there is as such no loss of sensitivity except the slow drift in sensor base line. In case of ZnO lines neither of these effects are seen. ZnO lines show reproducible response with very stable base line.

Furthermore, the ZnO sensors pursuant to the invention reveal that, as the dimension of patterned oxide is reduced from 2D (thin film) to 1D (100 nm nanolines), there is not only improvement in sensitivity (S=53% as compared to 10% of ZnO thin film) but also base line is fairly stable (Drift rate: ˜0 Ω/min as compared to ˜10 Ω/min for ZnO thin film and 31 Ω/min for commercial TGS sensor; Loss of sensitivity: ˜0%/min as compared to 0.9%/min for ZnO thin film and 3.6%/min for commercial TGS sensor). It should be noted that TGS821 is especially designed for hydrogen sensing by doping it with Pd which is a good catalyst for hydrogen whereas ZnO doesn't contain any kind of catalyst. Even though it performs better than TGS821. Furthermore, response of ZnO lines is better than those reported in literature for ZnO nanorods and nanowires, which are single crystalline structures. This is because of polycrystalline structure of ZnO which allows one to exploit both the surface as well as grain boundary effects in gas sensing, while the sensitivity of single crystal nanowire is only due to surface effect. If ZnO lines are doped with Pd, its sensitivity to hydrogen can be enhanced manifold. Doping of ZnO using sol-gel route is fairly straightforward and cost effective. In addition, while the positioning of nanorods and nanowires into device architecture is a challenge, soft-EBL can fabricate such kind of nanostructures with similar dimension and position them site specifically in a seamless manner.

### Discussion

The present invention is advantageous for use where there is a risk of explosion such as in hydrogen detection, where there is a desire to reduce power consumption compared to heated sensors or a desire to employ battery power, and where there is a need for a stable sensor microstructure over time which reduces or eliminates the need for periodic calibration and base line correction. Potential applications of the invention include, but are not limited to, gas sensing in safety and/or environmental monitoring and homeland security as well as food and beverage quality control, flavor and fragrances evaluation, disease detection with breathe analysis, and airport quarantine procedures.

Although the invention has been described in detail above with respect to certain illustrative embodiments, those skilled in the art will appreciate that changes and modifications can be made therein within the scope of the invention as defined in the append claims.

### APPENDIX I

### Experimental Set-Up

### Hardware

Model number of the instruments and their purpose is listed below:

### 1. Multifunction Switch/Measure Mainframe (Model: Agilent 34980A) and 40-Channel Multiplexer Card (Model: Agilent 34921A):

NanoNose™ uses Agilent 34980A Multifunction Switch/Measure Mainframe Unit with built-in precision 6.5 digit digital multimeter (DMM) and Model 34921A 40-Channel plug-in-type Low Frequency Multiplexer Card with Low Thermal Offset for high speed switching and data acquisition from an array of sensor. The 34291A 40-channel multiplexer is divided into two banks with 20 latching switches (1-20 and 21-40) in each for voltage and resistance measurements. This module also offers four additional fused relays (channel 41-44) for making AC and DC current measurement with internal DMM. Using the program commands, 34921A can be configured into three modes:
two independent 20-channel 2-wire MUXes.
one 20-channel 4-wire MUX. For the 4-wire resistance measurements, instruments automatically pairs channel n on bank 1 with channel n+20 on bank 2 to provide source and sense connection.
One 40-channel 2-wire MUX. This type of configuration can be had connecting Bank 1 and Bank 2 by closing the analog bus channels 913 and 923 or by externally connecting COM1 and COM2.

There are eight slots available on the back panel of 34980A. By using eight 34921A cards 2-wires MUX configuration can be expanded upto 320-channels. NanoNose™ uses only Slot 1 and can accept only 40 sensors in two independent 20-channel 2-wires MUXes configuration.

Measurement functions and their range allowed by the 34921A Multiplexer Card and 34980A DMM are:

| | | | | |
|---|---|---|---|---|
| AC Volts | 100.0000 mV-300.0000 | V | 3 Hz-300 | kHz |
| (True RMS) | | | | |
| DC Volts | 100.0000 mV-300.0000 | V | | |
| AC Current | 10.00000 mA-1.000000 | A | 3 Hz-5 | kHz |
| (True RMS) | | | | |
| DC Current | 10.00000 mA-1.000000 | A | (<0.1 V-<2 | V) |
| Resistance | 100.0000 Ω-100.0000 | MΩ | 1 mA-500 | nA |
| (2-Wire | | | | |
| and 4-Wire*) | | | | |
| Temp. | −200° C. to 600° | C. | | |
| (RTD from | | | | |
| 49 Ω-2.1 KΩ) | | | | |
| Frequency* | 100.0000 mV-300.0000 | V | 3 Hz-300 | kHz |
| Period* | | | | |

*(Cannot be configured by NanoNose ™)

The 34980A includes USB, Ethernet, and GPIB as standard interfaces to the PC for data communication and control. In the present set-up NanoNose™ communicates with 34980A via GPIB interface. For the detailed specifications and operation of 34980A and 34921A user is referred to the 34980A User's Guide.

### 2. Multichannel Flow/Pressure Controller (Model: MKS Type 647C) and Mass Flow Controller (Model: MKS1479A)

The MKS Type 647C is a multichannel controller which provides both pressure and flow control. Up to four mass flow channels and one pressure channel are allowed for mass flow control mode (independent gas flow) or upstream pressure control mode (ratio-based gas flow), and are controlled locally from the front panel or remotely using analog RS-232 interface.

NanoNose™ is designed to operate 647C in mass flow control mode and supports four N₂ calibrated MKS Type 1479A Mass Flow Controllers (MFC's) for accurate (1% of full scale) measurement and control of the flow rates of different gases. 1479A flow controllers are available in variety of flow ranges such as 10, 20, 50, 100, 200, 500, 1000, 2000, 5000, 10,000, and 20,000 sccm (N₂ equivalent).

Power and set point commands to 1479A are provided by 15-pin D-connectors at the real panel of 647C.

For the details of specifications and operation instructions of 647C and 1479A, user is referred to the corresponding manuals.

### 3. Sensor Excitation Sub-System (Model: Keithley 2420 Source Meter)

Purpose of sensor excitation sub-system is to modulate the operating temperature of chemical sensors in an array. NanoNose™ uses Keithley Model 2420 Source Meter to generate highly stable DC power source for biasing the sensor heater. Using the Temperature Settings tab in NanoNose™, Model 2420 can be programmed to generate low noise DC voltage in Constant Mode as well as in Sweep Mode at the maximum power rating of 3 A/60 W. Model 2420A is programmed via GPIB.

For the details of specifications and operation instructions of Model 2420A, user is referred to the User's Manual.

### 4. Other Peripherals

Gas chamber: The gas chamber is fitted with Agilent 34921T Terminal Block (see sec. 2) for interfacing with Agilent 34921A Multiplexer Card through a pair of 39-pin D-Connectors. Sensors are mounted on PCB board and hardwired with the 34921T terminal blocks. On the font side of the gas chamber are provided a pair of connectors for powering sensor heaters using Keithley Model 2420 Source Meter. Gas chamber has two sets of inlet and outlets—one for gas delivery and flushing and other for cooling the gas chamber with running water. To ensure the proper flow of the test analyte through the gas chamber, a flow meter is connected to the gas outlet.

On the front panel of gas chamber there are couple other BNC and Triax connectors provided which can be used for interfacing the sensors with Keithley Model SCS4200 Semiconductor Characterization System and HP4294A Gain/Phase Analyzer. These instruments can be controlled separately for acquiring the data from the gas sensor. NanoNose™ in this type of configuration is used to simply control the gas delivery.
Gas sensors: NanoNose™ is compatible with two types of sensors —Chemoresistve device with embedded heaters and MOSFET sensors. Chemoristive type of sensors can be connected to Channel 3 to 40 of the 34921T for direct measurement of change in resistance whereas drain currents of MOSFET are measured by channel 41 to 44. For biasing MOSFET device, contact NanoNose™ technical support.
Humidity sensor: Channel 2 and 3 are dedicated for monitoring fluctuations in ambient humidity and temperature which can be detected by an integrated circuit humidity sensor with integral RTD (Honeywell HIH-3602-C, 0-100% RH, −40° C. to 85° C.). A separate socket for 5V power supply for driving humidity sensor is provided at the front panel of the gas chamber. Humidity sensor is mounted on the same PCB where the gas sensors are mounted. Integrated 1000Ω RTD of the humidity sensor provides information about the temperature near the gas sensors and is displayed as Chip Temperature on the Scan tab of NanoNose™.
Temperature sensor: As additional 100Ω thin-film RTD element (Minco Inc. Model: Wire-bound and Thin-Film RTD Element—S249PD12) can be connected to the channel 1 for monitoring chamber temperature, displayed as Chamber Temperature on the Scan tab of NanoNose™.
   Test gases: As there are only four MFCs, one of them can be used for carrier gas (Nitrogen) and other three can be used for test gases. If the test analyte is in the form of liquid a bypass stream comprising a fraction of the carrier gas is bubbled through a reservoir of the test analyte held at constant temperature in a Precision 180Series Water Bath. By maintaining a constant flow rate and selectively varying the ratio of carrier gas to vapor-containing stream, a wide concentration range of the test vapor streams can be generated. Both the multilevel dilution as well as gas mixture can be had by altering the physical connections of the MFCs and configuring the MFCs Diagnostics and MFCs Settings tabs of NanoNose™.

### 5. Supported Platform for NanoNose™:

Supported platform and operating system to operate the NanoNose™ are
System Requirements: Pentium 4 or equivalent processor and 256 MB of RAM
Ports: 1 Serial port for RS232 communication
Plug-in Card: Keithley Model KPCI-488 IEEE-488.2 GPIB Interface Board for the PCI Bus
Operating System: Windows 2000/NT 4.0 Service Pack 6 or later/XP
Software: LabView 7.1, MS Office (MS-Excel)
Drivers: LabView Driver for
   IEEE 488 Interface Card
   Agilent 34980A Multifunction Switch/Measure Unit
   MKS Type 647C Multi Channel Flow/Pressure Controller, and
   Keithley 2420A Source Meter

### Software—NanoNose™

Solid-state chemical sensors find applications in many areas ranging from environmental monitoring to pollution control and from security to quality control. Response of these sensors being function of ambient conditions (e.g. temperature and humidity) and background environment, they must be thoroughly characterized prior to the field application to ensure reliable detection of suspect chemical. NanoNose™, a state-of-the-art software tool developed in LabView, allows rapid prototyping, testing and evaluation of chemical sensors in different experimental conditions likely to be encountered in actual field testing. When used with its companion platform that comprises of embedded PC based switch/measure unit and automated gas delivery and mixing system, NanoNose™ offers an unique and very effective system for rapid and high through-put capability to analyze multiple sensors and their performance.

Salient features of the NanoNose™ are:
i. Simultaneous characterization of multiple sensors (Sensor Selection & Diagnostics GUI): Upto 37 resistive type sensors, two temperature sensors and one humidity sensor in 2-probe configuration, and 10 MOSFET devices can be simultaneously characterized with high precision and speed. Response of resistive type sensors is recorded as a direct change in resistance whereas responses of MOSFET sensors are measured as a direct change in its drain current. GUI is graphical user interface.
ii. Real-time monitoring of ambient conditions: Wide range of temperature variation from −40° C. to 85° C. and relative humidity from 0% to 100% can be measured and recorded as additional piece of information while acquiring data from the sensors array.
iii. Advanced sensor excitation: Sensors in an array can be characterized by exciting them from room temperature to several hundreds degree Celsius (about 600° C.) above the room temperature. Both static and dynamic modes of operation are possible. Under the dynamic mode of operation temperature can be swept either—sinusoidally, rectangular fashion, saw tooth fashion or triangularly at variable duty cycle and frequencies over predefined minimum and maximum temperatures. Dynamic change of operating temperature allows modulation of the kinetics of gas-solid interaction which can be used to improve sensor performance by subsequent signal processing techniques. With the proper changes in the hardware setup this feature (Temperature Settings GUI) can also be used to excite the sensors under light illumination, both static and dynamic—a novel method of detecting the gases at room temperature. Like operating the gas sensors under dynamically changing temperature, dynamic light illumination may be used to provide plethora of useful information about gas solid-interaction and hence can be used to detect suspect chemical with even greater confidence.
iv. Synthetic environment for simulated experiments (MFC Diagnostic and MFC Settings GUI): With the help of high precision mass flow controllers (MFCs) simulated experiments can be performed by exposing the sensors to the test gases in highly controlled and precise amount at different flow rates and concentrations same as encountered in actual field testing. A predefined exposure sequence of single or multiple gases (such as binary and tertiary mixture) can be set for an unattended experiment over an extended period of time. By altering the physical connections of the MFCs and configuring NanoNose™ both the multilevel dilution for low level detection and as well as mixture analysis can be performed.
v. Real time detection (Scan and Data Acquisition GUI): Response of selected sensors to the test sequence together with fluctuations in local humidity and temperature can be monitored in real-time and exported to excel spreadsheet for offline analysis.

Once the sensors are installed, entire settings right from sensor selection to method of sensor excitation and from selection of test gas to their mixing and delivery can be programmed through user friendly graphical user interface (GUI). Sensor array response are measured and recordered through software triggered array scanning with program control data transfer displayed in real-time and entire process is initiated, controlled and terminated by software itself with minimal, albeit no human interference with the hardware setup. One of the unique features of the NanoNose™ is subroutine for test-setup diagnostic. To ensure proper functioning of the sensors and MFCs, hardware diagnostic can be run prior to the start of experiment. This is important for running an experiment for a long period of time.

Over and above, other unique applications and utility of the NanoNose™ tool are:
It can not only be used to study gas sensor response but can also be used to perform accelerated testing for sensor aging and stability under unfavorable conditions such as exposure to sufficiently high concentrations and aggressive environment and extremely low/high humidity and ambient temperatures.
It can be applied to generate chemical data base by exposing the array of sensors to different test chemicals both individually as well as in mixture which can be further as reference point during field testing.
It can also be employed for real-time monitoring of toxic chemicals inside the building. This can be obtained by interfacing signal processing and data analysis tools with the sensor outputs for on-line analysis and recognition.

However, as per the user's requirement NanoNose™ offers flexibility to be configured for advanced sensors as well (such as MOSFET Cantilever Gas Sensor and SAW Sensors) and can be customized to perform other sophisticated experiments to study gas sensing properties of solid state materials and devices.

For further information, see A. K. Srivastava and Vinayak P. Dravid, On the performance evaluation of hybrid and mono-class sensor arrays in selective detection of VOCs: A comparative study, Sensors and Actuators B: Chemical, Vol. 117, Issue 1 (2006) 244-252 and NanoNose™ User's Manual, Northwestern University (2006), both incorporated herein by reference.

### APPENDIX II

### Identification and Quantification of VOCs

### Artificial Neural Network Identification of VOCs

In order to identify the volatile organic compounds (VOCs) with the nano-patterned sensors, data processing scheme shown in FIG. 11 was used. An array of three ZnO sensors illuminated with varying UV intensities (corresponding to 4.0, 3.8 and 3.6V bias across UV LED) was exposed to different five different VOCs (ethanol, methanol, acetone, benzene and chloroform) at varying concentrations. Different UV intensities were used to provide varying degree of sensitivity to the sensors for each of the test VOCs. Before subjecting the response of sensors to artificial neural network (ANN¹) for identification, data sets thus generated were simplified by projecting them into 2D feature space using principal component analysis (PCA). We used first two principal components (PC1 and PC2 having cumulative variance of 90.1%) to project the sensor response into 2D space which shows well separated clusters of the test VOCs with an ordered spatial distribution along the direction of increasing concentrations. By projecting the data sets in 2-D space of the calculated PCs, a correlation between the relative positions of the objects (score plot) and contribution of each sensor in defining the PC (loading plot) can be visualized. Thus, PCA not only reveals redundant information in the data set and helps selecting important features (sensors), but also groups the data with similar characteristics (group of vapors) by reducing high dimensional data set to low dimensional data set. ¹ Artificial neural networks (ANN) is a pattern recognition technique that to a certain extent mimics ability of human brain. ANNs are interconnected architecture of artificial neurons that can learn, memorize and create relationships amongst data similar to biological brains.

Use of low dimensional PCA transformed data set has an advantage during ANN training. It prevents ANN learning from the problem of premature convergence and hence improves its generalization capability.

To classify the test VOCs using ANN data sets thus generated were first normalized between 0 and 1 and then partitioned into two parts: one part to be used for training and the other part for testing. Of the total data set about ⅔rd was used for training the neural network and the remaining ⅓rd data, which were never ever shown to the network, were used for testing. Both the training and testing data sets consist of input and output vectors. Input vectors represent PC scores of the test VOCs. Each input vector has a corresponding output (target) vector. For the identification problem the output vectors corresponding to the vapor in the training data set are fixed as 0.1, except for that corresponding to the vapor represented by input vectors which is set to 0.9. For the quantification problem output vectors vary between 0 and 1 corresponding to the normalized concentrations.

Three-layered feed forward neural networks with sigmoidal activation function² was designed to learn response of nano-sensors to test VOCs. Two types of neural networks were constructed—one for identification and other for quantification. Input layer consists of two nodes corresponding to PC1 and PC2, whereas output layer contains nodes equal to the number of vapors requiring discrimination (for the quantification purpose, output layer consisted of only one node to predict the concentration of test vapor). Number of nodes in the input layer was chosen by trials. After the network is built, learning was performed using backpropagation algorithm³. Learning occurs according to the defined gradient (initialization condition), learning rate (α) and momentum term (η). Learning parameters α and η were optimized by “grid experiments” for fixed small number of learning cycles. The point on the grid that corresponds to the minimum mean square error (MSE) represents best choice of the learning parameters. Once the optimum values of the learning parameters are available, network is trained for larger number of iterations. Two termination criteria were set for the neural network leaning: mean square error (MSE) as 0.001, and maximum number of leaning cycle to 20,000. To avoid the over-training ‘train and test’ method was used in which as the training proceeds network is validated using the test data or validation data at frequent intervals. Initially MSE for both training and testing data sets decrease and after reaching a certain minimum, errors on the test data starts increasing whilst the errors on training data keeps on decreasing. The point where errors on test data begin to increase, training is stopped. A large number of experiments with repeated restarts and different weight initializations were performed to achieve best classification and quantification results. However, ANN training was comparatively easier and there was as such convergence {³ Learning process in feed-forward neural network can be viewed as the problem of updating connection weights so that a network can efficiently map input pattern of the training data set to the corresponding target outputs. Backpropagation algorithm which was originally proposed by Rumelhart et al. in 1986 [3] is the most popular learning technique for feed-forward neural networks. It uses gradient descent technique to update the weights. This method minimizes the derivative of error function, which take a fixed step in the direction of the negative of the gradient, E(w). Minimization proceeds in a series of steps, with the weight connection from unit j to unit i being updated at each step, and derivative being re-evaluated for each new set of weights according to the expression problem. The reason being the data sets used for ANN training were already grouped and well separated. Further, Due to their inherent parallel processing capability ANN classifiers we built showed excellent generalization capability (ability to recognize unseen pattern) and were tolerant to noise, sensor drift and sensor failure.{² A feed-forward neural consists of fully interconnected layers of identical processing units, neurons. Output from a neuron fans to other neurons in following layer via synaptic link, called weights. Input layer contains as many nodes as there are sensors, while output layer contains nodes equal to the number of vapors requiring discrimination. Number hidden layers and nodes in each hidden layer are fixed by trials as depicted below:

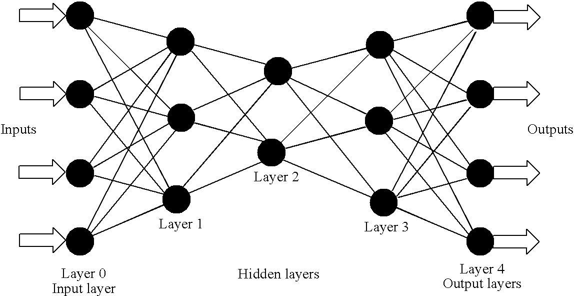

However our simulation results show that the three layered neural network (having only one hidden layer) with sigmoidal processing unit, shown below, can perform any non-linear mapping to any desired degree of accuracy}.

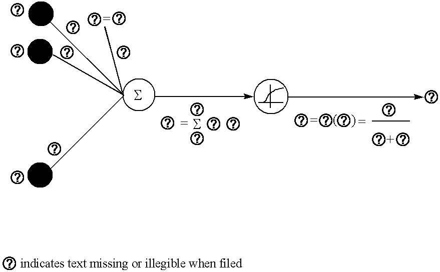

$${Δω}_{ji}^{( τ )} = - α \frac{\partial E}{\partial {ω}_{ji}} {\vert}_{{ω}^{( τ )}} + {ηΔω}_{ji}^{( τ - 1 )}$$

where τ denotes number of steps in learning cycle and the parameter α is called learning rate. The second term is used to improve the stability of learning process (by making the network come out of local minima entrapment) and is called momentum term, with η being momentum rate.}

### Implementation of Backpropagation Trained Neural Network

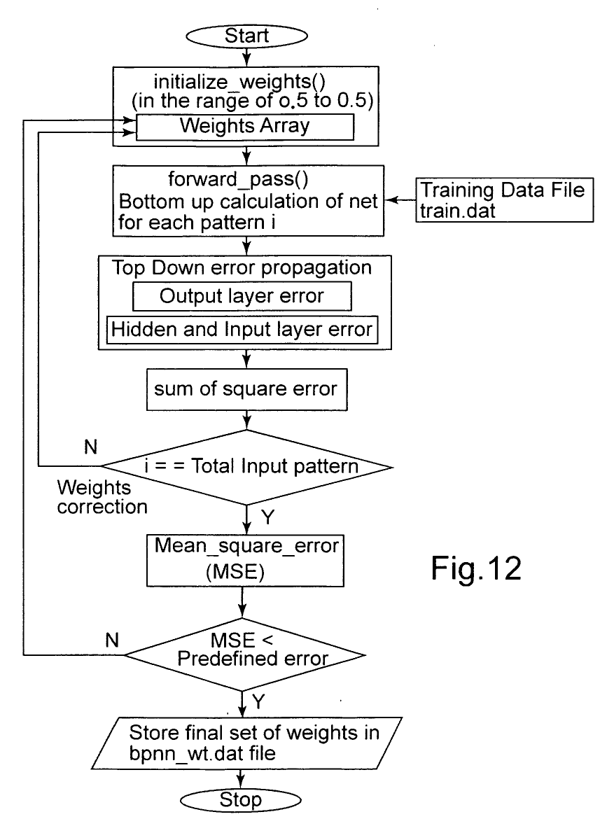

Backpropagation training of neural network was implemented into the computer as per the flow chart shown in FIG. 12.

User friendly simulation software written in high level programming language C was developed to simulate multilayer feed-forward neural network of any topology. The BPNN simulator has two modes of operation. User is queried first which mode of operation is desired: Training or Testing?

In the Training mode user is required to supply following information:

| | |
|---|---|
| task name | : train |
| # of features in input patterns | : |
| # of output units | : |
| # of input samples | : |
| momentum term | : |
| learning rate | : |
| max. total error | : |
| max individual error | : |
| max # of iteration | : |
| # of hidden layer | : |
| # of units in each hidden layer | : |
| random seed | : |
| weight initialisation range | : |
| learning cycle interval | : |

First of all net is built. User has flexibility to specify input and output units, number of hidden layers and number of hidden units in each layer. After the net is built, learning takes place in the net with a given set of training samples, train.dat (task name). This file contains exemplar pairs or patterns. Software allows simulation of network of any topology with the training data set of any size. However the maximum size of the network and dimension of patterns are declared to be as:

| | | |
|---|---|---|
| #define NMXUNIT | 25 | /*max. no. of units in a layer*/ |
| #define NMXHLR | 5 | /*max. no. of hidden layers*/ |
| #define NMXOATTR | 25 | /*max. no. of output features*/ |
| #define NMINP | 100 | /*max. no. of input samples*/ |
| #define NMXIATTR | 25 | /*max. no. of input features*/ |

As per the requirement of the problem i.e. if the network size is very large and the training set is sufficiently large and voluminous, these constants can be modified accordingly.

Network parameters like learning rate and momentum term can be varied in different simulation runs to find their optimum range. As the backpropagation follows gradient-descent rule (a single-point search), network initialised with a given set of random number (usually taken as very small say in the range of +0.5 to −0.5) may not lead to global solution. Due to this reason choice of different random seeds results in network initialisation with different set of random weights in the range (±0.5) specified by the user. Program terminates upon reaching the predefined tolerance errors or maximum number of iterations set by the user. There are two types of tolerance errors: total error (≈0.01) or mean of square individual error summed over all output units and over all input patterns (MSE); and individual error (≈0.001) or total absolute error summed over all output units for a given input pattern. After the learning is over, all the information relevant to the structure of net, including weights and threshold are stored in ASCII files. Structure of net, learning parameters and the calculated outputs are saved in train_v.dat whereas weights and threshold are stored in train_w.dat. To provide some idea of how the network has done, information about MSE with the learning cycle is presented in the end of simulation in a file called criter.dat.

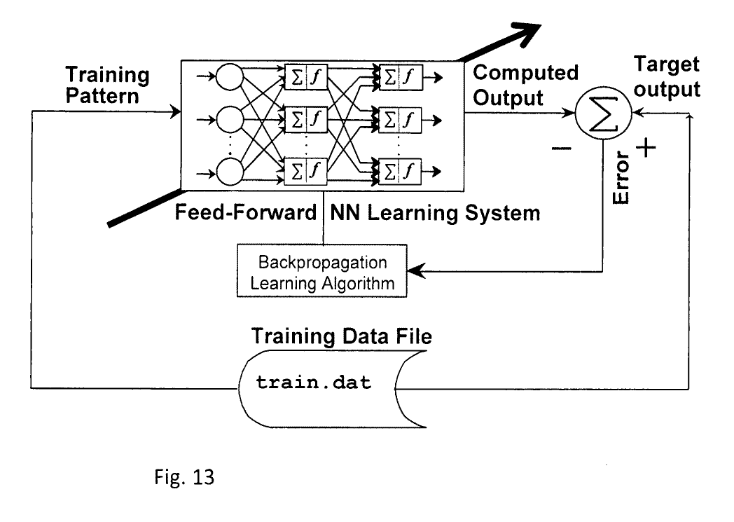

FIG. 13 shows schematic of the neural network training as described above. During the first phase of learning, called forward pass, input patterned stored in the file train.dat, presented to the network results in computed output. This output when compared with the target output results in an error signal. The second phase involves adjustment of weight variables according to the backpropagation learning rule until the error signal reduces to predefined tolerance limit or other termination criteria is met.

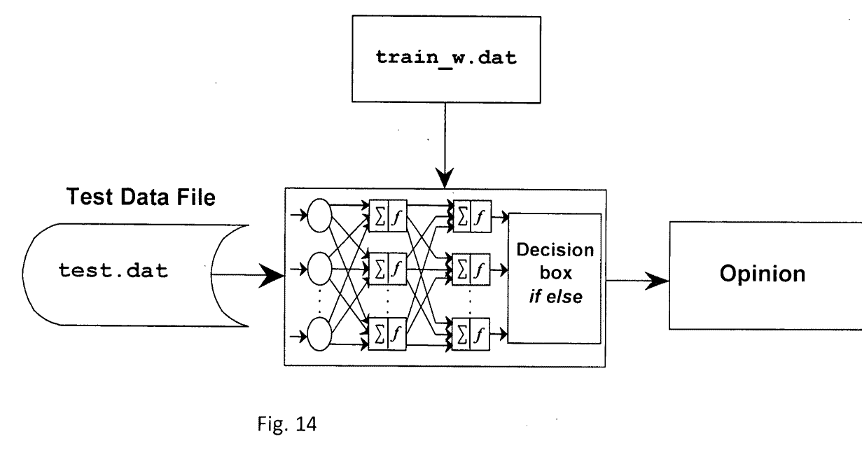

During the testing mode network is reconstructed using train_v.dat and test patterns stored in test.dat are presented and propagated forward through the network. Neural Network then classified the test patterns using the static knowledge base through the file train_w.dat, FIG. 14.

Following information is supplied to the program

| | |
|---|---|
| task name | : train |
| file to be processed | : test.dat |
| # of patterns | : |

Decision box compares tested outputs with the target values and gives its opinion whether the tested pattern belongs to the category of the samples to which network is trained. Outputs thus generated are saved in output.dat.Train.dat and test.dat are ASCII files.

For more information see, 1) A. K. Srivastava and Vinayak P. Dravid, On the performance evaluation of hybrid and mono-class sensor arrays in selective detection of VOCs: A comparative study, Sensors and Actuators B: Chemical, Vol. 117, Issue 1 (2006) 244-252; 2) A. K. Srivastava, Detection of volatile organic compounds (VOCs) using SnO₂ gas-sensor array and artificial neural network, Sensors and Actuators B: Chemical, Vol. 96 No. (1/2) (2003) 24-37, and 3) D. E. Rumelhart, G. Hinton, R. Williams, Learning representation by backpropagation errors, Nature 323 (1986) 533-536, all of which are incorporated herein by reference.

### REFERENCES

All of which are Incorporated Herein by Reference are:
[1] D. Kohl, Surface processes in the detection of reducing gases with SnO₂-based devices, Sensors and Actuators, Vol. 18 (1989) 71-113
[2] Rajeev K. Srivastava, P. Lal, R. Dwivedi and S. K. Srivastava, Sensing mechanism in tin oxide-based thick-film gas sensors, Sensors and Actuators, B: Chemical. Vol. 21, No. 3 (1994) 213-218.
[3] http://www.eere.energy.gov/
[4] S. A. Akbar and P. K. Dutta, Ceramic Sensors for Industrial Applications, in Encyclopedia of Materials: Science and Technology, Elsevier, (2001) 1080-1086.
[5] Donald A. Melnick, Zinc oxide photoconduction, an oxygen adsorption process, The Journal of Chemical Physics, Vol 26, No. 5, (1957) 1136-1146.
[6] X. L. Cheng, H. Zhao, L. H. Huo, S. Gao and J. G. Zhao, ZnO nanoparticulate thin film: preparation, characterization and gas-sensing property, Sensors and Actuators B: Chemical, Vol. 102, No. 2 (2004) 248-252
[7] S. K. Donthu, Z. Pan, B. Myers, G. S. Shekhawat, N. Wu, V. P. Dravid, Facile Scheme for Fabricating Solid-State Nanostructures Using E-Beam Lithography and Solution Precursors, Nano Letters, Vol. 5, No. 9, (2005) 1710-1715.
[8] A. K. Srivastava and Vinayak P. Dravid, On the performance evaluation of hybrid and mono-class sensor arrays in selective detection of VOCs: A comparative study, Sensors and Actuators B: Chemical, Vol. 117, Issue 1 (2006) 244-252.
[9] Roopali Srivastava, R. Dwivedi and S. K. Srivastava, Development of high sensitivity tin oxide based sensors for gas/odor detection at room temperature, Sensors and Actuators B: Chemical, Vol. 50, No. 3 (1998) 175-180.
[10] Y. Takahashi, M. Kanamori, A. Kondoh, H. Minoura and Y. Ohya, Photoconductivity of ultrathin zinc oxide films, Jpn. J. Applied Physics, Vol. 33, No. 12A (1994) 6611-6615.
[11] E. Comini, G. Faglia and G. Sberveglieri, UV light activation of tin oxide thin films for NO₂ sensing at low temperatures, Sensors and Actuators B: Chemical, Vol. 78, No. 1-3, (2001) 73-77.
[12] Chaonan Xu, Jun Tamaki, Norio Miura and Noboru Yamazoe, Grain size effects on gas sensitivity of porous SnO₂-based elements, Sensors and Actuators B: Chemical, Vol. 3, No. 2, (1991) 147-155.
[13] M. G. Ambia, M. N. Islam and M. Obaidul Hakim, Temperature-dependent studies on the electrical properties of pyrolytic ZnO thin film prepared from Zn(C₂H₃O₂)₂, Journal of Materials Science, Vol. 28, No. 10 (1993) 1573-4803.
[14] S. M. Sze, Physics of semiconductor Devices, Wiley-Interscience, New York, 1981, Chapter 5.
[15] B. Grover, B. McCarthy, Y. Zhao, G. E. Jabbour, D. Sarid, G. M. Laws, B. R. Takulapalli, T. J. Thornton and D. Gust, Kelvin probe force microscopy as a tool for characterizing chemical sensors, Applied Physics Letters, Vol. 85, No. 17 (2004) 3926-3928.
[16] Electric Techniques on Multimode™ Systems, Support Note 231, Rev. E, Digital Instruments Veeco Metrology (2001) 25-26.
[17] J. Saura, Gas-sensing properties of SnO₂ pyrolytic films subjected to ultraviolet radiation, Sensors and Actuators B: Chemical, Vol. 17, No. 3, (1994) 211-214.
[18] Oomman K. Varghese, Dawei Gong, William R. Dreschel, Keat G. Ong and Craig A. Grimes, Ammonia detection using nanoporous alumina resistive and surface acoustic wave sensors, Sensors and Actuators B: Chemical, Vol. 94, No. 1 (2003) 27-35.
[19] D. E. Rumelhart, G. Hinton, R. Williams, Learning representation by backpropagation errors, Nature 323 (1986) 533-536.
[20] A. K. Srivastava, Detection of volatile organic compounds (VOCs) using SnO₂ gas-sensor array and artificial neural network, Sensors and Actuators B: Chemical, Vol. 96 No. (1/2) (2003) 24-37.

1. A method of light-assisted sensing of one or more gaseous species, comprises contacting a gaseous medium with a material selected to adsorb on its surface one or more gaseous species of interest, illuminating the surface of the material to induce a change in an electrical property of the material, and measuring the change that is indicative of the presence of the one or more gaseous species of interest.

2. The method of claim 1 wherein the gaseous medium includes a volatile organic compound.

3. The method of claim 2 wherein the volatile organic compound is selected from the group consisting of methanol, ethanol, chloroform, acetone and benzene.

4. The method of claim 1 wherein the gaseous medium includes hydrogen.

5. The method of claim 1 wherein the gaseous medium includes oxygen.

6. The method of claim 1 wherein the gaseous medium is flowing relative to the material.

7. The method of claim 1 wherein the material comprises a polycrystalline thin film or line having a nano-grain size.

8. The method of claim 1 wherein the surface is illuminated with UV light.

9. The method of claim 8 wherein the UV light is pulsed on and off.

10. The method of claim 1 wherein each of multiple sensors of claim 1 are illuminated with a different UV light to detect different gaseous species.

11. The method of claim 1 wherein the sensor of claim 1 is illuminated with a periodically changing UV light to detect different gaseous species.

12. The method of claim 1 wherein the material comprise a metal oxide.

13. The method of claim 12 wherein the metal oxide comprises an n-type semiconductor metal oxide or a p-type semiconductor metal oxide.

14. The method of claim 12 wherein the metal oxide includes an element selected from the group consisting of Pd, Pt, Au, Ni, cu, Cd, Co, Ti, Al, Ru, and V.

15. The method of claim 1 wherein the electrical property is conductivity or resistance of the material.

16. The method of claim 1 including identifying and quantifying the gaseous species in the gaseous medium.

17. The method of claim 1 including contacting the gaseous medium concurrently with an n-type metal oxide material and a p-type metal oxide material and determining the change in electrical property of each material.

18. A light-assisted sensor comprising a material selected to adsorb on its surface one or more gaseous species of interest and a source of illumination for illuminating the surface of the material in a manner to induce a change of an electrical property of the material in the presence of the one or more gaseous species.

19. The sensor of claim 18 wherein the material comprises a metal oxide.

20. The sensor of claim 19 wherein the metal oxide comprises an n-type semiconductor metal oxide.

21. The sensor of claim 19 wherein the metal oxide comprises a p-type semiconductor metal oxide.

22. The sensor of claim 18 that includes both an n-type semiconductor metal oxide and a p-type semiconductor metal oxide.

23. The sensor of claim 18 wherein the material comprises a polycrystalline thin film or line having a nano-size grain size.

24. The sensor of claim 18 wherein the source comprises a UV light source.

25. The sensor of claim 18 wherein the source illuminates the material with periodically changing light.

26. The sensor of claim 18 wherein the electrical property is conductivity or resistance of the material.

27. The sensor of claim 18 wherein the material is disposed on an electrically insulating substrate and connected to electrodes.

28. The sensor of claim 18 wherein the metal oxide includes an element selected from the group consisting of Pd, Pt, Au, Ni, cu, Cd, Co, Ti, Al, Ru, and V.

29. The sensor of claim 18 wherein the material is unheated during exposure to the medium.

30. The sensor of claim 18 including electrodes in contact with the material in a manner to allow the change to be measured.

31. Multiple sensors of claim 18 each illuminated with a different light for use in detection of different gaseous species.
